(19) United States
(12) Patent Application Publication
(10) Pub. No.: US 2007/0288881 A1
(43) Pub. Date: Dec. 13, 2007

(54) Method of merging designs of an integrated circuit from a plurality of sources

(76) Inventors: Sreeni Maheshwarla, Sunnyvale, CA (US); Amitay Levi, Cupertino, CA (US); Elizabeth Cuevas, Los Gatos, CA (US)

Correspondence Address: DLA PIPER US LLP, 2000 UNIVERSITY AVENUE, E. PALO ALTO, CA, 94303-2248, US

(21) Appl. No.: 11/452,032

(22) Filed: Jun. 12, 2006

(51) Int. Cl. G06F 17/50

(52) U.S. Cl. 716/19; 716/3

(57) ABSTRACT

The present invention is a method by which a first party provides a first design for a first integrated circuit to a second party that has a second design for a second integrated circuit, whereby the first design is to be integrated within the second design, The method provides a mechanism to safeguard the intellectual property of the first design of the first party and the intellectual property of the second design of the second party from the other party, at the same time ensuring that the integration of the first design and the second design can occur. In particular, the peripheral interface information of the physical layout and electrical characteristics of the first design is provided by the first party to the second party. In turn, the peripheral interface information of the physical layout and electrical characteristics of the second design is provided by the second party to the first party. The first party matches the peripheral interface information from the first design with the peripheral interface information provided by the second party to verify the compatibility of merging the first design with the second design. Thereafter, if there is a match, a mask maker is notified to generate one or masks based upon the merged design of the first design and the second design as provided by the first party and the second party.

### TECHNICAL FIELD

The present invention relates to a method of merging a plurality of designs for an integrated circuit representing a merged design of the plurality of designs, whereby the plurality of designs are from a plurality of sources, and the intellectual property of the design from each source is protected.

### BACKGROUND OF THE INVENTION

Integrated circuit designs and fabrication are well known in the art. In the design of an integrated circuit, the designer usually creates the design for the integrated circuit in software. The design, in software form, takes into account the electrical and process (masking layer) interface requirements to the eventually formed integrated circuit. In addition, once the design is finalized, the design can be transferred to a mask maker, who would make one or more masks which would be used to fabricate the integrated circuit.

As designs for integrated circuits become more complex, it is often easier and less costly for a designer of an integrated circuit to design just a portion of an integrated circuit, and “purchase” or otherwise obtain rights to other portions of the design from other sources. The theory is similar to that of “why reinvent the wheel.” Thus, the designer for a novel integrated circuit may choose to design only a first portion, which is proprietary and novel, while licensing or obtaining rights to a second portion, which has been used widely in the industry. For the designer of the second portion, the problem becomes one of how to protect the intellectual property in that second portion so that the design can be “licensed” or otherwise transferred for remuneration without the fear that it would be subsequently “leaked” to the public. Although the design for the second portion may ultimately be incorporated into a product, and from a theoretical view point, it is possible to “reverse engineer” that second portion, the economic challenges of reverse engineering that second portion, once it is in a product form, makes the task of reverse engineering far less likely. The risk of the intellectual property residing in the second portion being lost or otherwise purloined is greater when the design is still in software form.

The problem, of course, is reciprocal for the design of the first portion of the integrated circuit, in that the designer does not wish to have that first portion disclosed (except as necessary to make the necessary masks for fabrication of the integrated circuit die).

In the prior art it was known to create layouts for masks and then block portions of the mask when delivered by one party to another party to interface therewith.

### SUMMARY OF THE INVENTION

Accordingly, in the present invention, a method for merging a design of an integrated circuit from a first source with a second source, to facilitate the fabrication of a merged design of an integrated circuit is disclosed. Peripheral interface information of the physical layout and electrical characteristics of a first integrated circuit is provided from the first source to the second source. Peripheral interface information of the physical layout and electrical characteristics of a second integrated circuit is provided from the second source to the first source. The peripheral interface information from the first source is matched against peripheral interface information from the second source to verify the compatibility of merging the first integrated circuit with the second integrated circuit. Upon verification of a match, one or more masks for an integrated circuit having a design representing the merging of the design of the first integrated circuit with the second integrated circuit, otherwise known as an embedded integrated circuit, are made.

### BRIEF DESCRIPTION OF THE DRAWINGS

FIG. 1 is a plan view of the merging of one design for an integrated circuit into another design for an integrated circuit to form a merged design of an embedded integrated circuit.

FIG. 2 is a perspective view of the merging of one design for an integrated circuit into another design for an integrated circuit to form a merged design of an embedded integrated circuit.

FIG. 3 is an plan view of the peripheral interface information from one designer matched with the peripheral interface information from another designer to verify the compatibility of the merging of the two designs.

FIG. 4 is a flow chart of one embodiment of the method of the present invention.

FIG. 5 is an illustration of the flow of database information between the designers of the two integrated circuit designs, to a mask shop, and then back to the original designers of the integrated circuit designs for verification.

### DETAILED DESCRIPTION OF THE INVENTION

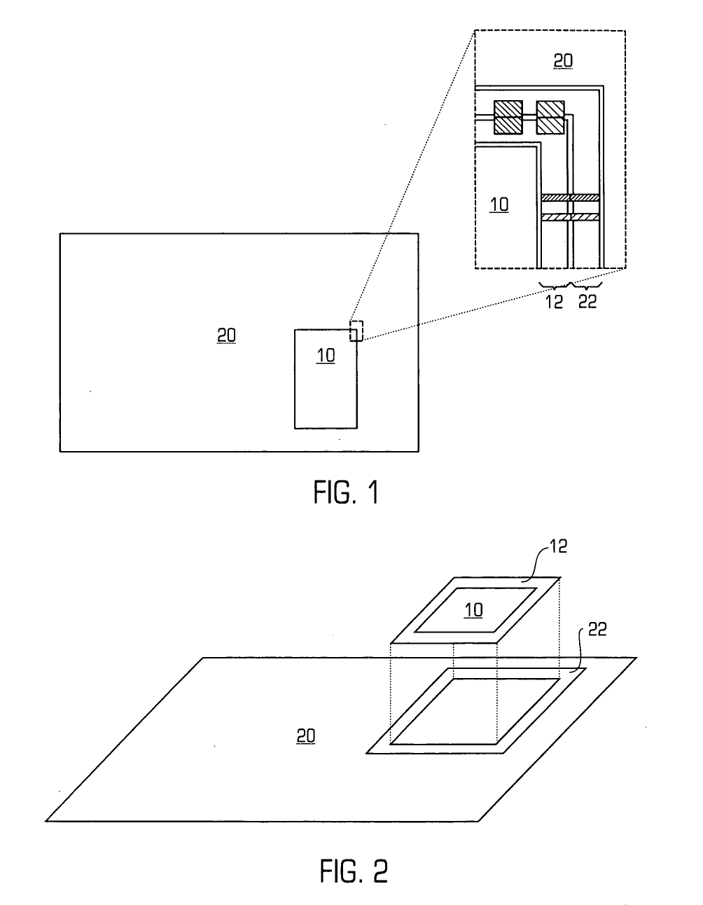

Referring to FIGS. 1 and 2 there is shown a plan view and a perspective view, respectively, of the merging of one design 10 for an integrated circuit, such as an array of non-volatile memory cells, from Silicon Storage Technology, Inc. of Sunnyvale, Calif., into another design 20 for an integrated circuit, such as microcontroller, to form a merged design of an integrated circuit with an embedded array of non-volatile memory cells to store program code and/or data. It should be noted that with the method of the present invention, the invention is applicable to the merging of any type of integrated circuit with another integrated circuit performing any type of function, including but not limited to memory, logic, controller, or even analog circuits, to form merged or embedded integrated circuits.

As previously discussed, each designer of the designs 10 and 20 would like to keep its design proprietary from the other designer. The problem, however, is that each of the designs 10 and 20 must be merged in a way that is compatible with the other design 20 or 10, as the case may be, such that the resultant design can function as a unitary integrated circuit device, or an embedded integrated circuit, or an embedded IC.

The present invention offers a solution to the foregoing problem. In particular, during the design of 10 or 20, a peripheral ring 12 or 22 is added to the design 10 or 20 as the case may be. In the preferred embodiment of the present invention, the peripheral rings 12 and 22 are substantially rectangularly shaped, although it is understood that each of the rings 12 and 22 can be of any shape, such as any type of polygon, so long as when the designs 10 and 20 are merged one of the peripheral rings, such as the larger ring 22, exactly circumscribes the other ring, e.g. the smaller ring 12. Thus, the peripheral ring 12 or 22 contains layout information regarding the design 10 or 20, as the case may be. Such layout information includes, size, position, shape and location of the design 10 (including the ring 12) or the design 20 (including the ring 22). The width of the rings 12 and 22 are chosen such that no layer in IP will violate the design rules with the layers in the finished chip.

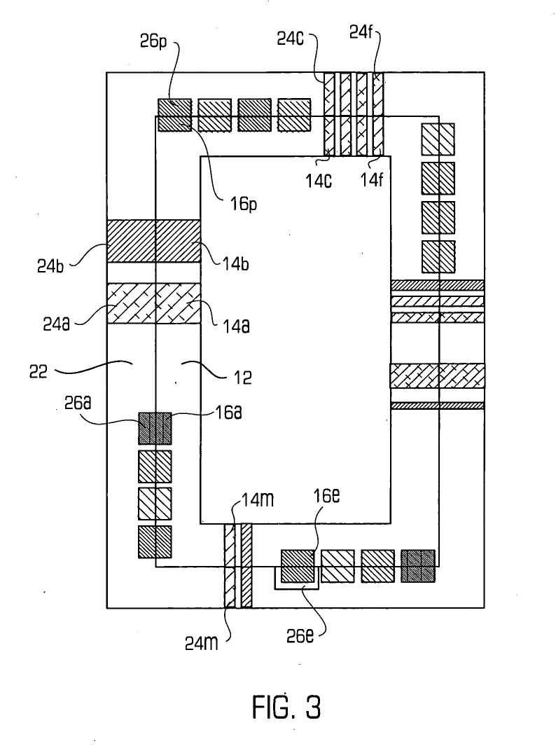

Referring to FIG. 3, there is shown in greater detail exemplars of rings 12 and 22. Each of the rings 12 or 22 contains one or more first indicia, such as 14(a-m) and 24(a-m), substantially in the shape of a bar having a width, extending though the ring 12 or 22 to indicate the electrical connection between the designs 10 and 20. Because each of the first indicia 14(a-m) and 24(a-m) may be on different metallization or conductive layers, each of the first indicia 14 and 24 is patterned to be visually distinct from one another. Thus, for example, first indicia 14a is patterned in a “brick” pattern that is different from the pattern of the first indicia 14b. However, the pattern of the first indicia 14a is the same as the pattern of the first indicia 24a, which also has a “brick” pattern, indicating they are the same masking layer. Thus, when there is a match between the first indicia 14a and 24a, a continuous rectangularly shaped bar having the same pattern extends from one side of the ring 22 to the other side of the ring 12. Further, each of the first indicia 14(a-m) and 24(a-m) has a width which matches the width of the corresponding first indicia from the other design.

Each of the rings 12 or 22 also has a plurality of second indicia, such as 16(a-p) and 26(a-p), that correspond to one another. These second indicia are positioned along the periphery of each of the rings 12 and 22 and are placed so that they abut and join one another. In the preferred embodiment, since the rings are rectangularly shaped, the second indicia 16(a-p) and 26(a-p) are distributed along all four sides of each of the rectangularly shaped rings 12 and 22. In the preferred embodiment, each of the second indicia is in the shape of a half square, although this is not the only possible shape. Thus, when the rings 12 and 22 are matched, if there is a match in the merging of the design 10 to design 20, each of the second indicia 16(a-p) and 26(a-p) form squares. Each of the second indicia 16 and 26 is associated with a mask layer used to fabricate the integrated circuit of the design 10 or 20. Since the data for each of the mask layers can be positive or negative, the transparency or the color of the second indicia 16 or 26 is used to indicate whether the mask polarity is positive or negative. In the preferred embodiment, in the event the data for the mask is a negative polarity, the second indicia 16 or 26 is transparent, and in the event the data for the mask is a positive polarity, the second indicia 16 or 26 is opaque. In the merging of the design 10 with the design 20, the polarity of the data for the mask at each layer must match. Therefore, if there is a match in the polarity of the mask between the design 10 and the design 20, then the second indicia 16 and 26 would form a complete square of the requisite transparency, i.e. either a complete opaque or complete transparent square.

The second indicia 16(e) and 26(e) is a special case. If the layer polarity of one party, for example 16(e), is different from the layer polarity of the other party, e.g. 26(e), then second indicia 16(e) is drawn as a square, while 26(e) is drawn as a U-shaped polygon. Therefore, in the mask shop, one of the layers is reversed to match the layer definition (polarity of the digitized data), and after the reversal the layers when merged would form a complete square (or rectangle) as in for example 16(a)/26(a).

In the method of the present invention, each party which is the designer of the designs 10 and 20, makes its design of the integrated circuit with its associated ring 12 or 22 as the case may be. The ring 12 or 22 is then exchanged with the other party. Each party then attempts to match its design with its associated ring (12 or 22, as the case may be) with the ring (22 or 12) received from the other party. In attempting to match the design, the party reviews information such as characteristics of electrical connection (both location and size of the electrical connection) between the rings 12 and 22 and the size and location of the merged designs including the polarity of the masks to be used.

In the event, there is no match, then each party will inform the other as to the reason for the mismatch and adjust their designs accordingly until there is a match. A match consists of: the size and location of the rings 12 and 22 results in the rings 12 and 22 being immediately adjacent and contiguous with one another; the electrical characteristics of the designs 10 and 20 match as determined by the electrical connection represented by the first indicia 14 and 24, and the polarity of the data for the masks match as determined by the second indicia, 16 and 26. In the event of a match, each party will deliver its design including the associated ring 12 or 22 to a mask shop. The designs are then merged by the mask shop.

For final verification, the mask shop generates the final merged design data, but omitting the design of the IC from one party for the other party to review. Thus, for final verification, the mask shop would generate the “jobview” for the design 20 with the rings 22 and 12 to the designer of the design 20. A “jobview” is similar to a print preview of a document, except the “jobview” shows the data on what the ultimate masks would look like. Similarly, the mask shop would generate the jobview for the design 10 with the rings 22 and 12 to the designer of the design 10 for final review. Once both parties have completed their review and concur that proper merging is achieved, the mask shop would generate the masks of the merged design data. The masks are then used to fabricate an embedded integrated circuit device having both designs 10 and 20, (including rings 12 and 22) on appropriate wafers, which are then separated into dies. Finally, the dies are packaged and distributed.

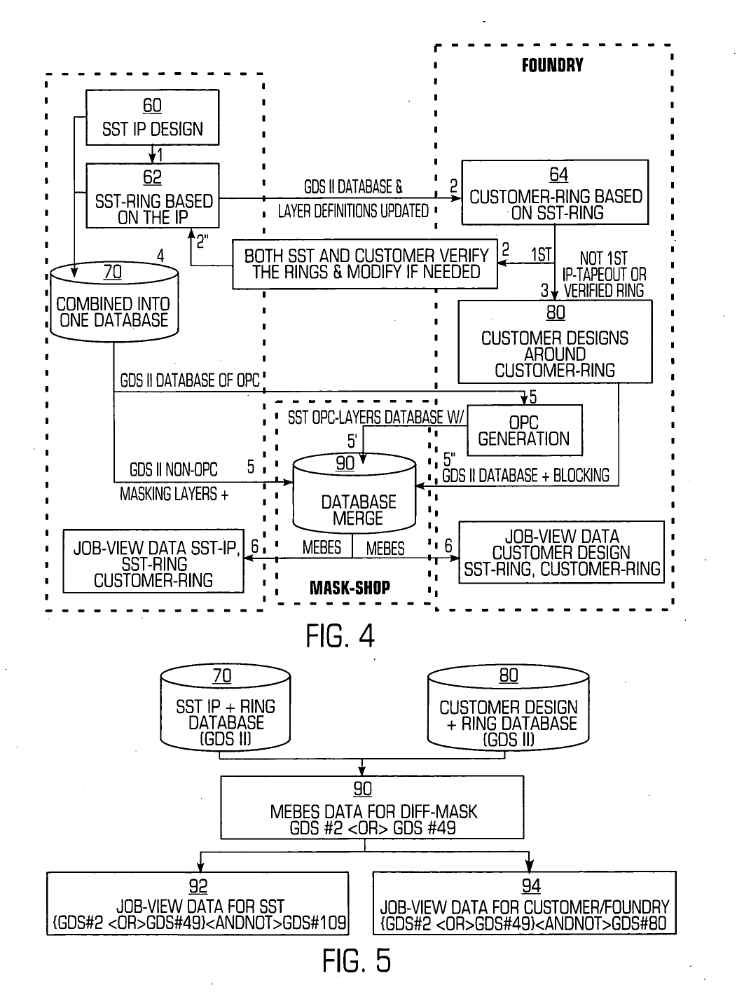

There are at least two possible ways by which the method of the present invention may be practiced. Referring to FIG. 4, there is shown a flow diagram of the merging of the design 10 (such as a Non-volatile memory array) from a first source (such as Silicon Storage Technology Inc. of Sunnyvale, Calif. or SST), to a design (such as an embedded controller) created by a second source, using the design library of a foundry party. The first party 60 creates its ring based IP 62 comprising the design 10 with its associated ring 12. The ring 12 is supplied to the foundry, where the customer of the foundry creates its ring 22 based upon the ring 12 supplied from the first party 60. The ring 22 from the customer of the foundry is returned to the first party 60 to verify that there is a match with the ring 12 provided by the first party to the foundry. The customer of the foundry and the first party 60 continue to work with each other's rings until there is a match by both parties. The first party 60 combines its IP with its ring 12 into a database 70.

The GDS databases for the OPC (Optical Proximity Correction) are then supplied to the foundry, where the OPC is generated and then the GDS II OPC database is sent to the mask shop 90. The GDS II Non-OPC database of the design 10 and its ring 12 from the first party 60 is also supplied to a mask shop 90. The database of the design 20 along with its associated ring 22 is also supplied by the customer of the foundry or by the foundry to the mask shop 90. The database of the designs 10 and 20 along with the associated rings 12 and 22 are merged by the mask shop 90. The mask shop 90 produces a job view showing the design 10, ring 12 and ring 22 to the first party 60, and the design 20, ring 22 and the ring 12 to the customer of the foundry. Once the parties, the customer of the foundry and the first party 60 verified that there is a match, the mask shop 90 makes the masks. The foundry takes the masks created by the mask shop 90 to produce the integrated circuit device which is a merger of the designs 10 and 20.

A second way of practicing the method of the present invention is for the first party, the designer of the design 10, and the second party, designer of the design 20 to deal directly with each other. Under this method, the first party 60 creates its ring based IP 62 comprising the design 10 with its associated ring 12. The ring 12 is supplied to the second party who creates its ring 22 based upon the ring 12 supplied from the first party 60. The ring 22 from the second party is returned to the first party 60 to verify if there is a match with the ring 12 provided by the first party to the foundry. The second party and the first party 60 continue to work with each other's rings until there is a match by both parties. The design 10 or 20 as the case may be, of each party along with its associated ring 12 or 22 as the case may be, is created in a GDS II database. The databases are supplied to a mask shop 90, which merges the two databases. After merger, the mask shop 90 prepares jobview of the merged database, except for the design 20 to the first party, and the merged database except for the first design 10 to the second party. The parties then check the designs returned and if there is a match, the mask shop 90 is then authorized to manufacture the masks for the merged design data.

There are many advantages of the present invention. First, the intellectual property or IP of each party is protected, while the parties are exchanging interface information permitting the parties to use and create merged designs of integrated circuit devices from both parties without disclosing its IP to the other party. Second, although a physical band is created ultimately in the masks in the nature of the peripheral rings 12 or 22, thereby suggesting that the present invention “wastes” precious “real estate” in a chip, the peripheral rings 12 and 22 serve to isolate one design from another. Thus, a designer of design 10 can confidently route electrical signal or connectors along the edge of the peripheral ring 12, within the boundary of the design 10 knowing that there is at least a separation of the width of the peripheral rings 12 and 22 from any electrical connectors in the design 20, without violating any design rule. Third, the polarity of the data in the masks as evidenced by the second indicia 16 and 26, also serves as polarity of data to indicate regions for implants, thereby assuring that areas of the implants are the intended areas, and not of the opposite polarity. Fourth, many designers also desire to protect their proprietary OPC, Optical Proximity Correction, algorithms, which “corrects” for optical loss in different mask layers. With the method of the present invention, designers can be assured that not only their circuit designs are protected but also the proprietary OPC algorithms are also protected. Fifth, labels of the electrical connection, such as ground or Vdd, can be applied to the second indicia 16 and 26 so that the function of the second indicia 16 and 26 are also communicated to the other designer. Finally, Layout Versus Schematic (LVS) checks can be run based soely upon the data supplied from the peripheral rings 12 and 22.

From the foregoing, it can be seen that there are many advantages of the method of the present invention, including but not limited to protecting intellectual property of each designer.

What is claimed is:

1. A method of merging a design of an integrated circuit from a first source with a second source, to facilitate the fabrication of a merged design of an integrated circuit; said method comprising:
providing peripheral interface information of the physical layout and electrical characteristics of a first integrated circuit from the first source to the second source;
providing peripheral interface information of the physical layout and electrical characteristics of a second integrated circuit from the second source to the first source;
matching said peripheral interface information from the first source to the second source to verify the compatibility of merging the first integrated circuit with the second integrated circuit; and
generating, upon verification of a match, one or more masks for an integrated circuit having a design representing the merging of the design of the first integrated circuit with the second integrated circuit.

2. The method of claim 1 wherein the physical layout portion of the peripheral interface information of the first integrated circuit from the first source is in a polygon shaped first ring.

3. The method of claim 2 wherein the physical layout portion of the peripheral interface information of the second integrated circuit from the second source is in a substantially similarly polygon shaped second ring, which circumscribes the first ring.

4. The method of claim 3 wherein the polygon is substantially rectangularly shaped.

5. The method of claim 1 wherein the peripheral interface information further containing an indicia indicative of the polarity of the mask to be made therefrom.

6. The method of claim 5 further comprising:
fabricating one or more integrated circuit dies from said one or more masks.

7. The method of claim 6 further comprising:
assembling one or more integrated circuit dies fabricated into packaged integrated circuit devices.

8. A method of merging the designs for an integrated circuit from a first design from a first source with a second design from a second source, to facilitate the fabrication of a merged design of the integrated circuit, said method comprising:
providing peripheral interface information of the physical layout and electrical characteristics of the first design from the first source to the second source;
receiving peripheral interface information of the physical layout and electrical characteristics of the second design from second source by the first source;
matching the peripheral interface information from the first source with the second source by the first source to verify the compatibility of merging the first design with the second design; and
notifying a mask maker to generate one or more masks by the first source upon verifying a match.

9. The method of claim 8 wherein the physical layout portion of the peripheral interface information of the first design from the first source is in a substantially polygon shaped first ring.

10. The method of claim 9 wherein the physical layout portion of the peripheral interface information of the second design from the second source is in a substantially similarly polygon shaped second ring, which circumscribes the first ring.

11. The method of claim 10 wherein the polygon is substantially rectangularly shaped.

12. The method of claim 11 wherein the peripheral interface information further containing an indicia indicative of the polarity of the mask to be made therefrom.

13. The method of claim 12 further comprising:
fabricating one or more integrated circuit dies from said one or more masks.

14. The method of claim 13 further comprising:
assembling one or more integrated circuit dies fabricated into packaged integrated circuit devices.
